(19) United States
(12) Patent Application Publication
(10) Pub. No.: US 2014/0197626 A1
(43) Pub. Date: Jul. 17, 2014

(54) MULTILAYER STRUCTURE INCORPORATING AT LEAST ONE SECURITY ELEMENT

(71) Applicant: ARJOWIGGINS SECURITY, Boulogne-Billancourt (FR)

(72) Inventors: Thibault Le Loarer, Pommier de Beaurepaire (FR); Alice Genet, La Buisse (FR); Jean-Yves Leroy, Restinclieres (FR)

(73) Assignee: ARJOWIGGINS SECURITY, Boulogne-Billancourt (FR)

(21) Appl. No.: 14/212,867

(22) Filed: Mar. 14, 2014

Related U.S. Application Data
(63) Continuation of application No. PCT/IB2012/054771, filed on Sep. 13, 2012.

(30) Foreign Application Priority Data
Sep. 14, 2011 (FR) 1158193

(51) Int. Cl. B42D 15/00; B44F 1/10

(52) U.S. Cl. CPC B42D 15/0013; B44F 1/10
USPC 283/85; 428/201; 428/138; 428/166; 428/196; 428/29

(57) ABSTRACT

A multilayer structure incorporating at least one security element. The multilayer structure includes a substrate made of a thermoplastic material with at least one non-opaque region. The multilayer structure further includes an external layer. An internal layer is disposed between the substrate and the external layer. The external and internal layers are made of a thermoplastic material. An opening in the internal layer defines a security region. An insert having a non-opaque security element is at least partially disposed within the security region. The security element and the non-opaque region of the substrate at least partially overlap.

### CROSS-REFERENCE TO RELATED APPLICATIONS

This nonprovisional application is a continuation of and claims priority to PCT Patent Application No. PCT/IB2012/054771, entitled “MULTILAYER STRUCTURE INCORPORATING AT LEAST ONE SECURITY ELEMENT,” filed Sep. 13, 2012, which claims priority to French Patent Application No. FR 11/58,193 having the same title and a filing date of Sep. 14, 2011, both of which are herein incorporated by reference.

### BACKGROUND OF THE INVENTION

1. Field of the Invention

This invention relates to a security element. More specifically, it relates to a security element integrated intended for integration into a laminated structure, such as an identification card.

2. Brief Description of the Related Art

The invention is notably applicable, but not exclusively to any laminated structure comprising at least one integrated electronic device.

In order to protect a document, a known solution is to use security elements referred to as “first level” which comprise security elements detectable by the naked eye in visible light and without the use of a particular apparatus and/or security elements referred to as “second level” which are only detectable with the aid of a relatively simple apparatus such as a lamp emitting in the ultraviolet or the infrared. It may turn out to be desirable to use security elements referred to as “third level”, capable of generating a specific signal when subjected to an optoelectronic, electric, magnetic or electromagnetic excitation.

Multilayer structures are known from the publications EP 2 116 366 A1, WO 03/095218 A1, WO 2011/072818 A1 or EP 1 719 637 A2.

Cards with an RFID device made of plastic material, only comprising polymer layers, are known and have little or no authentication securities, notably visual, except for security printing, surface embossings or holograms applied by transfer, such as that marketed by the company Hologram Industries under the DID trademark.

It is relatively easy for a fraudster to obtain blank plastic cards and to reproduce the printed features, personal details and visual security features present on an authentic plastic card.

More recently, metal reflecting elements on which a micro-pattern is etched and incorporated within a layer of polycarbonate have been marketed by the company BAYER under the PROTEXXION trademark. The elements are only identifiable visually with the aid of a microscope, and there is no security provided by the structure of the card itself.

There is a need to provide multilayer structures offering sufficient security guarantees and allowing, if desired, new visual effects to be produced for the observer trying to authenticate the card.

However, in view of the art considered as a whole at the time the present invention was made, it was not obvious to those of ordinary skill in the field of this invention how the shortcomings of the prior art could be overcome.

### BRIEF SUMMARY OF THE INVENTION

The long-standing but heretofore unfulfilled need for multilayer structures offering sufficient security guarantees and allowing, if desired, new visual effects to be produced for the observer trying to authenticate the card is now met by a new, useful, and nonobvious invention.

According to a first of its aspects, one subject of the invention is a multilayer structure comprising a substrate made of a thermoplastic material with at least one non-opaque region. The multilayer structure further includes a first external layer and a first internal layer disposed between the substrate and the first external layer; both layers are made of a thermoplastic material. The first internal layer defines a first security region. A first insert having a first security element is at least partially disposed within the first security region. The first security element and the non-opaque region of the substrate are at least partially superposed.

“Non-opaque” should be understood to mean not totally opaque; this could be an entirely translucent or transparent region.

The structure may thus have at least three superposed layers of plastic material.

Thanks to the invention, by virtue of its construction, the structure provides a security against forgeries and counterfeits.

The first security element offers a security feature which is advantageously of level 1 or 2, this feature consisting for example of a watermark or pseudo-watermark, a micro-printing, a pattern formed by metallization or demetallization, amongst other possibilities. The first security element may comprise a coded image that is only discernible through a revelation screen, the coded image comprising for example interlaced images producing, when observed through a revelation screen, with a change in the direction of observation or a relative movement of the screen and of the image, a animated sequence. Examples of such securities are disclosed in the publications FR 2 940 179, FR 2 948 216, FR 2 948 217 and FR 2 948 218 from the applicant. The security feature is notably other than defined by the shape of the contour of the insert.

The insert does not extend over the whole extent of the structure when the latter is observed face on. The insert is preferably surrounded by the first internal layer, when the structure is observed face on. Alternatively, the insert may take the form of a strip extending or not from one edge of the structure to the other. The insert may be compensated in thickness by the first internal layer, the thickness of the insert preferably being substantially equal to that of the first internal layer. The thickness of the insert is preferably in the range between 10 and 200 μm. The thickness of the first internal layer is preferably equal to that of the insert with an accuracy of ±20 μm.

The insert may be made of a fibrous material or otherwise, being for example made from one or more natural fibrous materials such as cellulose and/or one or more synthetic materials. The insert may be made of paper reinforced with synthetic fibers. The insert may have one or more layers, notably when it is non-fibrous, for example a thermoplastic support layer and a metallic pattern layer.

The structure according to the invention may be a card complying with the dimensional specifications of the standard ISO10373.

The invention offers a safety for plastic cards, provided by the structure of the card itself, and not only by printed security features or holographic patches.

The safety obtained by the invention is very difficult to counterfeit because it requires industrial technical means owing to the fact that it extends to the internal structure of the card, in contrast to a holographic patch for example, only disposed on the surface and which can therefore easily be removed.

The invention allows, with the first insert, at least one security to be provided of level 1 and/or 2 and/or 3, localized within the security region and observable, depending on the case, in transmitted and/or reflected light, or even by a movement of the structure or by means of a device designed for the detection of a security feature, for example a reader of a marker, a particular illumination such as an LCD screen or of a mobile telephone or an external revelation screen.

In exemplary embodiments, the invention provides a security of level 1, thanks to the first security element, this security feature being situated at a non-zero distance from the outside surface of the card. This feature is for example a watermark or pseudo-watermark, or a coded image that must be observed through a revelation screen or a lens array, or a revelation screen or a lens array.

The multilayer structure according to the invention advantageously comprises an electronic device, preferably at least partially integrated into the substrate. In this case, notably, the substrate is also referred to as “inlay” and may be composed of one or more layers.

The electronic device may be chosen from amongst integrated microcircuits with contactless communication, microcircuits with an antenna integrated onto a chip, resonant microcircuits, microcircuits communicating by electromagnetic waves, micro-transponders, micro-transponders photo-activatable notably by a laser beam, and micro-transponders reacting to a beam of light, for example of diffuse light.

The electronic device may be programmable or not. The electronic device may be read only or read/write.

The structure may comprise a device with integrated microcircuit using contact communication and a device with integrated microcircuit using contactless communication, or even a device with integrated microcircuit allowing both reading through contact and contactless reading.

The electronic device according to the invention may in particular comprise two electronic modules, one for the technology with contact, the other for the contactless technology.

The electronic device may be capable of communicating with an external reader. “External reader” denotes any device that allows communication with the device, its activation, its authentication, data to be read which are contained within it, these data to be received and, where necessary, to be modified, or even to be partially or entirely deleted. The external reader may operate remotely or may require a contact.

The device may result from the association of a chip with at least one antenna, in the case of a contactless system.

A chip comprises, for example, a semiconductor base, in general a wafer of doped silicon, sometimes made of a semiconducting polymer, and also in general comprises a memory, or even one or more microprocessors, allowing data to be processed. In order to operate, it may receive the energy from a battery or be powered by a source of electrical energy supplied by a contact and/or a contactless means remotely by means of a communications interface via an antenna. The chip is for example connected to the antenna through a contactless power supply of the inductive or capacitive type. The chips with an antenna are called “transponders” and generally use radiofrequency waves.

In the case where the device is said to be “active”, the chip may comprise a battery, also referred to as “micro-battery”, integrated into its microcircuit or the chip may be connected to a micro-battery integrated into the structure. A “battery” should be understood to mean a source of electrochemical energy, either rechargeable or otherwise.

The chip may also be powered by a photovoltaic system.

The antenna of the device with an integrated contactless microcircuit may be of the wired, printed, notably using serigraphy, etched, glued, transferred, chemically deposited type, formed by electro-deposition, or else carried by the device with integrated microcircuit. The antenna is preferably wired, being more mechanically resistant than an antenna formed by serigraphy.

According to one exemplary embodiment, the device with integrated microcircuit is flush with at least one face of the structure. The device with integrated microcircuit may or may not be flush with each of the faces of the substrate, being for example entirely accommodated within the thickness of the substrate.

The device with integrated microcircuit may be associated, for example connected, with one or more additional electronic device(s), chosen from within the following list: a light-emitting system, notably a LED or OLED, a display device, for example a screen, a sensor, a coupling antenna, and a switch.

The electronic device or devices may be supplied with electricity by a battery present on the device with integrated microcircuit, notably by a micro-battery on a chip.

The electronic device or devices may alternatively be supplied by an internal or external battery, not present on the device with integrated microcircuit, for example a battery on flexible thin layers distinct from a chip, or by a photovoltaic cell, for example at least partially printed.

The electronic device or devices may alternatively be powered by capacitive or inductive coupling, for example during a communication between the device with integrated microcircuit and an external reader.

The electronic device or devices, and potentially the associated power supply device or devices, for example one or more batteries, may be accommodated within the thickness of at least one of the layers of the structure, notably within the thickness of the substrate, or as a variant be formed by printing on at least one of the layers of the structure, notably of the substrate.

When the electronic device comprises a microcircuit with an integrated antenna on a chip, this integrated antenna may be the only antenna or may be coupled to an amplifying antenna, otherwise referred to as a booster antenna, integrated into the substrate. The presence of such an antenna booster may allow the revelation range of the chip to be increased, for example by a factor equal to 10. Furthermore, such an antenna booster may provide a means for customizing the substrate.

The electronic device may have a dual HF/UHF frequency of operation, in order to allow the device, by virtue of the longer range radio link, to be prepared for later reading by the shorter range link.

The multilayer structure according to the invention described above, preferably further includes a second external layer made of a thermoplastic material. A second internal layer of thermoplastic material defining a second security region is disposed between the substrate and the second external layer. A second insert is disposed at least partially within the second security region, whereby the first and second inserts are at least partially superposed.

The thermoplastic material of the first and/or second external layer may be transparent or translucent.

The second insert may be non-opaque, in order to allow light to pass through the structure within the area of observation in a region superposed onto the first and second security regions.

The first security region may be bounded by a first opening or recess of the first internal layer, preferably an opening. The bottom of this recess is preferably transparent or translucent.

The second security region may be bounded by a second opening or recess of the second internal layer, preferably an opening. The bottom of this recess is preferably transparent or translucent.

The second insert may comprise a second security element, notably non-opaque. The second security element may comprise a security feature of level 1, 2 or 3. The first and second security elements may have security features of the same levels, for example level 1, and preferably of the same type, for example a watermark or pseudo-watermark. As a variant, the securities present on the first and second inserts are to be observed simultaneously in order to allow the user to verify the security feature.

Preferably, the first and second openings are at least partially superposed, each for example being bean shaped or of circular, oval or polygonal shape. Preferably, the openings are exactly superposed.

By virtue of the inserts, the structure according to the invention may comprise several securities which are combined together, which is the case when the observation of the structure allows security features to be observed respectively belonging to the first and second security elements, which complete or cooperate with each other.

When the first or the second insert is non-fibrous, the non-fibrous insert may comprise a multilayer structure, with for example a support layer and a layer carrying a pattern, for example formed by metallization or demetallization, as mentioned hereinabove. The support layer may be made of PET (polyethylene-terephthalate), for example.

The first and second inserts may respectively comprise a coded image and a revelation screen, each formed by metallization or demetallization, for example. Thus, by observing the structure through the insert comprising the screen, the coded image may be revealed, for example giving rise to an animated sequence when the direction of observation changes, by virtue of a parallax effect and interlaced images. The pattern formed by metallization or demetallization is preferably situated on the side of the support layer for the insert which is opposite to the substrate. The pattern may be covered with an adhesive.

According to another of its aspects, another subject of the invention is an article, notably a security document, in particular chosen from amongst an access or identification card, a page of a passport, a page of data relating to the carrier of the document, comprising a structure such as defined hereinabove.

According to yet another aspect, a further subject of the invention is a method of authenticating an article or a structure such as previously defined, in which an observation is made through the first securing element and the non-opaque region and information relating to the authenticity of the article or of the structure is extracted from this observation.

When the structure comprises a second external layer comprising a thermoplastic material, between the substrate and the second external layer, a second internal layer of thermoplastic material, defining a second security region with a second insert disposed at least partially within the second security region, the second insert comprising preferably a second security element, notably non-opaque, the first and second inserts being at least partially superposed, the method may comprise the observation of each security element from one corresponding face of the structure and the acquisition via this observation of information relating to the authenticity of the article or of the structure.

### BRIEF DESCRIPTION OF THE DRAWINGS

For a fuller understanding of the invention, reference should be made to the following detailed description, taken in connection with the accompanying drawings, in which:

FIG. 1 is a cross-sectional view of an embodiment multilayer security structure that is a dual UHF/HF frequency border crossing card with a dual watermark.

FIG. 2 is a cross-sectional view of an embodiment multilayer security structure that is contactless identity card having a dual watermark.

FIG. 3 is a cross-sectional view of an embodiment of multilayer security structure that is hybrid voting card with a dual watermark and demtallized microtext security.

FIG. 4 is a cross-sectional view of an embodiment of multilayer security structure that is a driver license with a dual contact or contactless interface system of communication.

### DETAILED DESCRIPTION OF THE PREFERRED EMBODIMENT

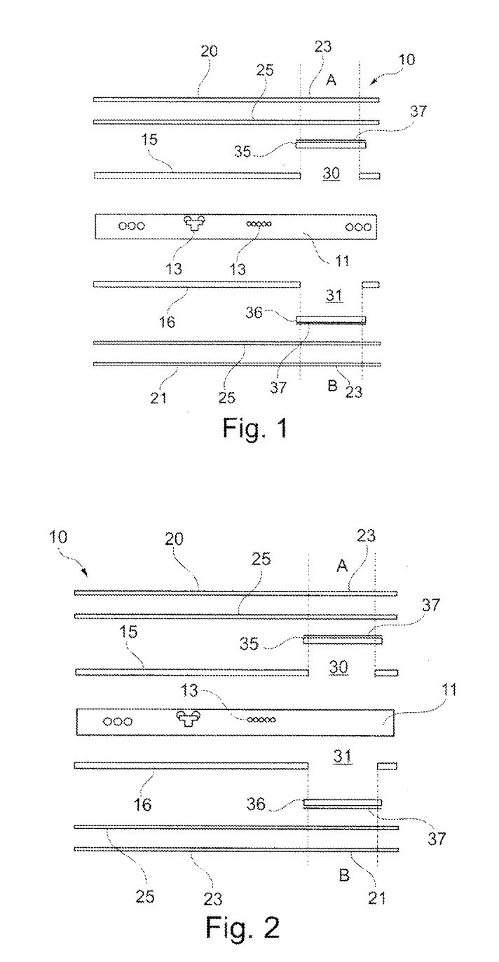

A structure 10 according to the invention may comprise, as illustrated, a substrate 11 carrying all or part of an electronic device 13, for example an identification device with integrated microcircuit, which may be with contact and/or contactless as previously detailed. In the case of a device using contacts, the latter comprises contacts 13a which are situated on an external face of the structure, in this case the lower face 21 in FIGS. 1 and 4, but as a variant this could be the opposite face,

Preferably, the structure 10 is a flat card of constant thickness, for example with a thickness equal to 760 μm+/−80 μm.

In the case of a device allowing a contactless communication, the substrate 11 (also referred to as inlay or core) may incorporate an antenna, preferably wired, which may be connected to a chip or electromagnetically coupled to the latter.

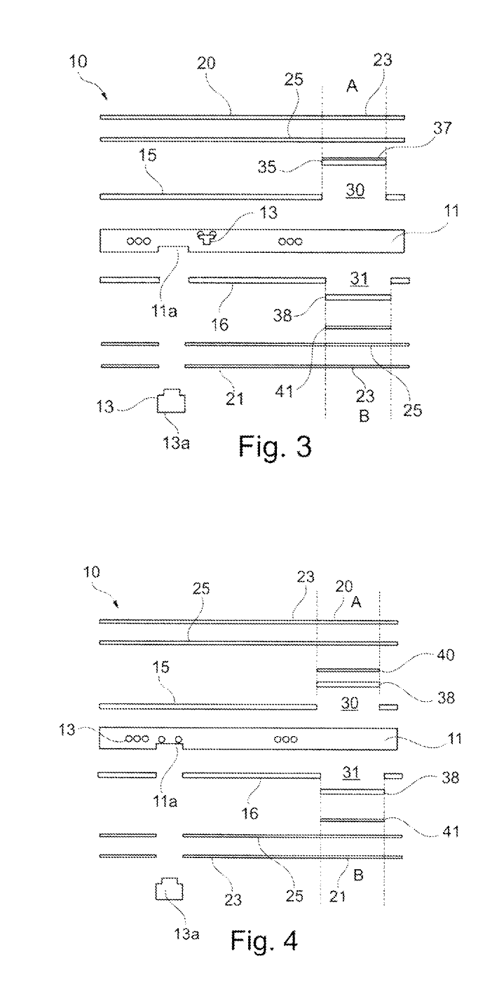

In the examples corresponding to FIGS. 1 and 2, the RFID device is contactless. In the examples in FIGS. 3 and 4, the RFID device allows both communication with contacts and contactless communication.

The substrate 11 may be a monolayer or multilayer substrate, being single or multi-material. Preferably, the substrate 11 shows a constant thickness, with the possible exception of the receiving area 11a for the chip, as in the examples in FIGS. 3 and 4, which may be recessed so as to partially accommodate the latter.

In the case of a contactless RFID device, the latter is for example entirely buried within the thickness of the substrate 11 and does not come flush to the interface of the substrate with the adjacent layers of the structure, as illustrated in FIGS. 1 and 2.

The structure according to the invention may comprise at least one apertured layer 15 disposed on the side of the substrate 11, or better two apertured layers 15 and 16 respectively disposed on either side of the substrate 11, as illustrated in FIGS. 1 to 4.

Additional layers may be provided between the apertured layers 15 and 16 and the external faces 20 and 21 of the structure 10, in order for example to carry printed features or laser markings.

In the examples illustrated, these additional layers number two on either side of the substrate 11, consisting of a transparent external layer 23, preferably of polycarbonate, with a thickness in the range between 25 and 75 μm, for example around 50 μm, and an underlying laser-markable layer 25, for example also made of polycarbonate, with a thickness in the range between 25 and 150 μm, for example around 50 μm or 100 μm.

In the examples illustrated, the additional layers 23 and 25 are the same on the recto or verso side of the structure 10, but the additional layers 23 and 25 could be different, for example by their nature, their thickness and/or their aspect.

The openings 30 and 31 of the apertured layers 15 and 16 define respective observation areas A and B on either side of the structure 10, preferably in which at least one security of level 1 and/or 2 and/or 3 is observable.

In the example in FIG. 1, a paper patch 35 having a security element consisting of a watermark or pseudo-watermark is disposed in the opening 30 of the apertured upper layer 15 and a second paper patch 36 is place in the opening 31 of the apertured lower layer 16. Each paper patch 35 and 36 is coated with a layer of adhesive 37 on at least one face, preferably that turned toward the adjacent layer 25, or even on both its faces. The second patch 36 preferably also comprises a watermark or pseudo-watermark.

The openings 30 and 31 may have the same shape in the apertured upper 15 and lower 16 layers; for example they may be circular with a diameter d. They may have another shape, for example polygonal or more complex.

The extent of each patch 35 or 36 may be slightly larger than that of the corresponding opening, in such a manner as to cover the edge of this opening. In the example where the contour of the opening is circular with a diameter d, the patch may have a diameter D>d. The difference between D and d is for example in the range between 1 and 3 mm.

The layers 15 and 16 are preferably non-transparent, being for example opaque and made of white polycarbonate.

The substrate 11 may be made from a transparent thermoplastic material, preferably polycarbonate, and the thickness of the substrate 11 is for example in the range between 300 and 400 μm, for example around 350 μm. The substrate 11 may also be translucent and diffuse light, in such a manner for example that a pattern present on the insert 35 is only visible from the side of the face 23, and in a reciprocal manner, a pattern visible on the insert 36 is only visible from the side of the face 21, owing to the diffusion of the light through the substrate 11. The term “translucent” is understood to mean the fact that the material of the substrate allows enough light to pass in order to see through the substrate. Polycarbonate exhibits natural optical properties endowing it with the necessary translucent and diffusing properties.

The light diffusing nature of the substrate 11 may come from its index of refraction, from its composition, from its thickness and/or also from its surface irregularities.

According to one particular case, the surface irregularities of the substrate may be obtained by embossing or graining of this surface.

According to another particular case, the substrate comprises cavitations endowing it with a diffusing nature, for example bubbles.

According to another particular case, the substrate comprises a diffusing charge chosen in particular from between mineral pigments, in particular kaolin or titanium dioxide, and organic pigments, in particular polystyrene or polyurethane beads.

The difference between the embodiments in FIGS. 1 and 2 comes from the nature of the contactless electronic device carried by the substrate 11, namely RFID and UHF dual frequency in the example in FIG. 1, and RFID device alone in the example in FIG. 2.

The two patches 35 and 36 may carry different watermarks or pseudo-watermarks, as level 1 security features.

It is advantageous for the substrate 11 to be translucent rather than transparent in the presence of patches each carrying a watermark or pseudo-watermark, as previously mentioned.

The watermarks are conventionally obtained during the wet-phase fabrication of a paper sheet by the deposition of paper paste onto embossed canvas from a cylinder paper mold machine, the quantity of paste deposited being higher in the hollows and lower on the bumps with respect to the rest of the paper.

The watermarks may also be formed by embossing of a wet sheet by a watermarker roll (also known as “dandy roll”) on a flat paper mold machine.

A further known solution is to form pseudo-watermarks on a paper sheet. Pseudo-watermarks reproduce the appearance of a watermark by exhibiting differences in opacity. These pseudo-watermarks may be obtained mechanically by applying pressure with or without heat and/or chemically by application of a composition, for example by locally increasing the transparency of the paper by means of suitable substances. The density of fibrous material between the lightest and the darkest regions of the pseudo-watermark may be uniform in contrast to a conventional watermark.

The pseudo-watermark may be produced within the finished fibrous layer of the paper patch by mechanical and/or chemical means by application of certain products, this image still being visible in transparency.

The pseudo-watermark may for example be formed by depositing or by printing in given areas of the fibrous layer a composition that modifies the transparency of the fibrous layer, notably in order to form light regions and dark regions, similar to those of a watermark, without however obtaining a result that allows details and variants in brightness comparable to those of a conventional watermark to be obtained.

The finished fibrous layer may for example be rendered transparent by applying, in given areas, for example a generally oily composition which permanently renders the fibrous layer transparent, such as for example a composition made from oil and transparent mineral material such as described in the U.S. Pat. No. 2,021,141 or such as for example a composition in the form of a wax combined with a solvent such as described in the U.S. Pat. No. 1,479,337.

The finished fibrous layer may also be rendered transparent by locally applying a wax by hot transfer, such as described in the U.S. Pat. No. 5,118,526.

Another solution is to use a fibrous layer comprising a thermo-fusible material, for example polyethylene, such as described in the patent EP 0 203 499, which, under the local action of the heat, will see its transparency vary.

The finished fibrous layer may be opacified, without however making it completely opaque, by applying an opacifying agent in given areas which increase the opacity of the fibrous layer, such as for example described in the patent application FR 2 353 676.

The opacifying agent may for example be an aqueous suspension of a pigment or of a charge or a solution of a chemical compound, of a colored compound or of a dye. This agent may be applied during the fabrication of the fibrous layer, onto the fibrous web, and before its removal from the fabric, in such a manner that the agent penetrates into the voids of the web and causes a modification of the opacity of the web to be treated in chosen areas, after drying. This fabrication technique has the drawback of requiring special roller devices for applying the agent, and of preferably employing an aspiration device in order to make the agent penetrate into the voids of the web.

A pseudo-watermark may furthermore be formed according to the method described in the document W. WALENSKI, “Watermarks and Those that Are Not”, Druckspiegel 52, no. 3: 66-68 (March 1997). This document describes a method of fabrication of a pseudo-watermark on a non-coated paper, comprising the application under heat and pressure of a marking element, representing the pattern of the pseudo-watermark, onto a re-wetted paper sheet.

The international application WO 97/17493 also describes the fabrication of coated paper comprising pseudo-watermarks resulting from a variation in the layer weight applied in given areas, which leads to a variation in thickness and in opacity in the zones where the layer weight is reduced or increased.

The international application WO 1999/014433 also describes another method of fabrication of a pseudo-watermark on a coated paper, which includes the formation of an image in the paper after the drying step which follows the last coating operation, by carrying out the steps in which a re-wetting solution is applied onto at least one face of the coated paper, in one or more given areas, and pressure and heat are applied in the area or areas of the re-wetted coated paper so as to evaporate the solution and to densify the coated paper in the area or areas with respect to the rest of the paper.

The pseudo-watermark may lastly be formed by mechanical means by creating marks by mechanical embossing of given areas of the fibrous layer such as described in the patent DE 3 718 452.

When two paper patches 35 and 36 each comprise a watermark or pseudo-watermark, the two watermarks or pseudo-watermarks may be different. In particular, the watermarks or pseudo-watermarks may be complementary. They may be complementary in their visual effect or with respect to a concept or an image. For example, in the case of a structure according to the invention, on one side a national emblem may be used as first watermark or pseudo-watermark, and as second watermark or pseudo-watermark on the other side, a text.

According to another exemplary embodiment, the two watermarks or pseudo-watermarks are identical but placed symmetrically. In the case of an authentication, it may then be advantageous to verify this identity between the watermarks or pseudo-watermarks on both faces of the structure (for example a person always looking the same way).

As previously indicated, it is advantageous, when the structure 10 comprises a watermark carried by at least one of the paper patches, for the latter to be superposed at least partially onto a translucent region of the rest of the structure, in such a manner that the watermark is only observable by light transmitted through the structure from the face of the structure adjacent to the paper patch in question. When the structure comprises two paper patches, each comprising a watermark or pseudo-watermark, the latter may only be observable by light transmitted through the structure, at its position, from the face of the structure adjacent to the patch in question. Thus, the observations of the watermarks or pseudo-watermarks are made separately from different respective faces of the structure.

In the example in FIG. 3, the structure comprises a paper patch 35 in the opening 30, and a non-fibrous patch 38 covered with a pattern 41 in the other opening.

In the variant in FIG. 4, the structure comprises two non-fibrous patches, for example each with a support 38 made of transparent polycarbonate, covered with different patterns 40 and 41.

In all the examples in FIGS. 2 to 4, it is advantageous, as mentioned with regard to the example in FIG. 1, for the patch to be slightly larger than the size of the opening, so as to slightly cover the apertured layer and to guarantee a continuity of the material situated between the substrate 11 and the adjacent layer 25.

In the various examples, the thickness of the insert 35, 36 or 38, 40 or 38, 41 is for example greater than 10 μm, being advantageously in the range between 70 and 150 μm.

The security element present on each insert 35, 36 or 38, 40 or 38, 41 may be viewed either by reflection, or by transmission, or by transmission and movement along one of the axes of the card, depending on the way in which the security elements are formed.

The method for laminating and the method for pre-assembling (furthermore referred to as collating) the various layers, together with the potential adhesives present between the layers, are chosen depending on the structure sought.

The structure according to the invention may comprise one or more security elements, chosen from the following, amongst others:
photochromic or thermochromic components, dyes and/or pigments, notably in printed form or mixed with at least one component layer of the structure,
a specific light collector material, for example of the “waveguide” type,
a multilayer interference film,
a structure with variables optical effects based on interference pigments or on liquid crystals,
a birefringent or polarizing layer,
a diffractive structure,
an embossed image,
means producing a “moiré effect”, where such an effect may for example result in the appearance of a pattern produced by the superposition of two security elements on the article, for example by bringing together lines of two security elements,
a refractive element that is partially reflecting,
a transparent lenticular array,
a lens, for example a magnifying glass,
a colored filter,
a security wire incorporated for example in the bulk of at least one component layer of the structure or in a window, which could comprise a printed feature printed as a positive or as a negative, a metallic, goniochromatic or holographic effect, with or without one or more demetallized parts,
a metallized, goniochromatic or holographic foil,
a layer with variable optical effect based on interference pigments or on liquid crystals,
a flat security element and with a relatively small format such as a planchette, visible or invisible, with or without electronic device,
particles or agglomerates of particles of pigments or dyes of the HI-LITE type, visible or invisible,
security fibers, notably metal, magnetic (with soft or hard magnetism), or absorbent, or excitable by light,
an automatically readable security having specific features of light absorption, of Raman activity, of magnetism, of microwave interaction, of interaction with X-rays or of electrical conductivity.

A printed feature may be formed on the internal face of the layer 23, recto and/or verso.

A printed feature may be formed on both faces of the layer 25, notably when the latter is thicker, such as in the example in FIG. 4, and has a thickness for example of around 100 μm of transparent laser-markable PC. When the layer 25 is thinner, and is only for example 50 μm in thickness, the latter may only be printed on its face turned toward the layer 23, for example. This or these printing operations may take place prior to the lamination of the various layers of the structure.

The transparent layer 25 of PC advantageously comprises charges or pigments that are markable by laser which allows customization of the structure 10 after the step for lamination of the various layers. On the other hand, the apertured layers 15 and 16 are preferably of a nature different from the layer 25 since they are preferably intended to receive a printed feature prior to the lamination step, forming a basic graphic with which the customized print on the layer 25 will be completed. Consequently, the apertured layers 15 and 16 have a chemical composition different from the layer 25. A spectral analysis would readily show the difference in chemical composition. In addition, the apertured layers 15 and 16 may comprise additives in order to obtain the white color, which further differentiates it from the layer 25.

### Example 1

### Contactless Identity Card with a Security of the Dual Watermark Type

The structure corresponds to that illustrated in FIG. 2. The substrate 11 and the layers 23 and 25 are made of translucent polycarbonate and the layers 15 and 16 of white polycarbonate, for example of 100 μm in thickness. The substrate 11 has a thickness of around 350 μm and the layers 23 and 25 are 50 μm. The patches 35 and 36 made of paper are watermarked and fabricated on a cylinder mold machine. The watermark of the patch 35 is obtained with a conventional galvano and the watermark of the patch 36 is obtained by the screened-image watermark technology of the applicant, described in the application US 2001/0018113. The final card has a thickness of around 760 μm+/−80 μm, thus complying with the standard ISO10373. The card is equipped with a system of contactless communication complying with the same standard ISO 10373.

The fabrication of the card comprises the following steps:
fabrication of the watermarked papers designed to form the patches 35 and 36,
deposition of the layer of adhesive 37, for example a polyurethane, in the areas of the watermarks of the papers,
perforation with a diameter d of the two layers of white polycarbonate (PC) 15 and 16,
cutting out of the watermarked areas at a diameter D in order to form the patches 35 and 36; D is preferably slightly larger than d, for example by around 1 to 2 mm, so as to allow a complete covering of the translucent area,
assembly of the patches 35 and 36 by means of the layer of adhesive 37 by hot stamping to the corresponding layer of PC 25, in such a manner that the patches 35 and 36 are disposed facing the perforations in layers of white polycarbonate (PC) 15 and 16, and in such a manner that the patches 35 and 36 and the corresponding layer of PC 25 are rigidly attached so as to facilitate the later steps for pre-assembly and for lamination,
pre-assembly of the various component layers of the card, namely white PC, transparent PC with patches pre-deposited by hot stamping, substrate,
formation by ultrasound of attachment points, or by application of a hot iron, in order to hold the stacked layers before lamination, for example on a machine of the Muehlbauer type.
hot lamination on a lamination press at a temperature of around 180° C. for around 20 min, the platen press being for example that marketed by the companies Lauffer or Burkle,
cutting out of the cards to the ID1 format,
graphic customization of the card, by a step for laser marking of the layer 25.

The layers of white PC 15 and 16 and/or the layers 23 and 25 may be offset printed and/or by serigraphy with a printed security feature, for example microtext, marker, etc.

The customization is carried out from card to card preferably by laser etching, for example on a Datacard machine, on the laser-markable layer 25. Alternatively, the customization may be carried out by inkjet.

### Example 2

### A Driver's License Card

A card is produced in the ID1 format for a driver's license with a dual contact/contactless interface system of communication, complying with the standard ISO 10373. The structure of the card is illustrated in FIG. 4. The substrate 11 is made of transparent PC with a thickness of 350 μm.

Coded-image security patterns 40 and 41 and a revelation screen such as described in the application FR 2 940 179 from the applicant are formed on support layers 38 of PET with a thickness of 10 μm using a technique of vacuum metallization/demetallization by laser ablation. Since the thickness of the PET support and of its pattern are very small, there is no need to compensate for the latter by forming an additional window in the layers 25 and 23. During the hot lamination, the flow of the plastic materials allows the thickness compensation.

The fabrication of the card comprises the following steps:
metallization of the support layers 38 of PET,
demetallization in order to form a first pattern 40 constituting a coded image,
demetallization in order to form a second pattern 41 constituting a revelation screen, complementary to the first pattern,
deposition of an adhesive, for example polyurethane, onto each pattern 40 and 41,
cutting out of the patches to a diameter D,
perforation at a diameter d (with d preferably less than or equal to D) of the two layers 15 and 16 of white PC, with a thickness of 100 μm,
assembly of the patches by hot stamping each with a layer 25 of transparent laser-markable PC, for example with a thickness of 100 μm, on a coil/format machine, for example from the company CTLay, the patches and the layer 25 are thus rigidly attached in order to facilitate the later steps for pre-assembly and for lamination,
pre-assembly of the various component layers of the card, namely the layers of white PC, the layers of transparent PC with patches, substrate, by ultrasound, for example on a machine of the Muehlbauer type,
hot lamination on a lamination press at a temperature of around 180° C. for around 20 min; a platen press marketed by the companies Lauffer or Burkle may for example be used,
cutting out of each of the cards to the ID1 format,
milling out for the location of the electronic module, on a Muehlbauer machine for example,
drilling of the holes in order to form the contact of the electronic module with the antenna,
deposition of conductive glue in the holes,
deposition of the adhesive within the cavity for the electronic module,
installation of the module,
numbering of the driver's license by embossing,
electronic customization of the card,
graphic customization of the PC.

The layers of white and/or transparent laser-markable PC may be offset printed and/or by serigraphy with a security printed feature, for example microtext, marker, etc.

The customization is carried out from card to card by laser etching on the transparent layer 25 of laser-markable PC, for example on a Datacard machine.

### Example 3

### Hybrid Voting Card with Dual Watermark and Demetallized Microtext Security

The structure of the card corresponds to FIG. 3. The card comprises two chips, one with contacts, the other contactless. The first insert 35 is a paper patch comprising a watermark. The watermark is only visible from one side of the structure. The second insert is a patch with a pattern 41 formed by demetallization, for example a microtext.

### Example 4

### Dual UHF/HF Frequency Border Crossing Card with Dual Watermark Security Feature

The structure of the card is that illustrated in FIG. 1. A border crossing card is produced equipped with two systems of communication 13 with different frequencies, namely UHF with its long range, which allows the reading of the card to be “prepared”, and HF with the RFID device for example at 13.56 MHz, in order to save time during the control at borders.

In all examples, the invention allows a card to be provided that is mostly made of plastic, preferably polycarbonate (PC), comprising a security of level 1 or higher, integrated directly into the actual structure of the card, rendering counterfeiting very difficult and forgery impossible.

The invention is not limited to the examples illustrated. Features of the various examples may be combined within variants not illustrated.

In particular, all of the layers of the structure, aside from the patch, are preferably of the same chemical nature, and for example composed of PC, of PVC, of ABS (Acrylo Butyl Styrene), of PETg, of PE, of PLA, of PMMA, etc. Alternatively, the layers of the structure, aside from the patch, may each be composed of a material of different chemical nature, for example chosen from amongst: PC, PVC, ABS (Acrylo Butyl Styrene), PETg, PE, PLA, PMMA, etc.

The expression “comprising a” should be understood as being synonymous with “comprising at least one”, except where the contrary is specified.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A multilayer structure, comprising:
a substrate comprising a thermoplastic material, having at least one non-opaque region;
a first external layer comprising a thermoplastic material;
between the substrate and the first external layer, a first internal layer of thermoplastic material, defining a first security region; and
a first insert disposed at least partially within the first security region, comprising a first security element which is non-opaque and other than defined by the shape of the contour of the insert, the first security element and the non-opaque region of the substrate being at least partially superposed.

2. The structure as claimed in claim 1, comprising:
a second external layer, comprising a thermoplastic material,
between the substrate and the second external layer, a second internal layer of thermoplastic material, defining a second security region,
a second insert disposed at least partially within the second security region, the second insert preferably comprising a second, security element, the first and second inserts being at least partially superposed.

3. The structure as claimed in claim 2, the second security element being non-opaque.

4. The structure as claimed in claim 2, the second insert being non-opaque.

5. The structure as claimed in claim 1, the first security region being bounded by a first opening or recess whose bottom is transparent or translucent, of the first internal layer.

6. The structure as claimed in claim 2, the second security region being bounded by a second opening or recess whose bottom is transparent or translucent, of the second internal layer.

7. The structure as claimed in claim 5, the first insert being more extended than the first opening.

8. The structure as claimed in claim 6, the first and second openings being superposed.

9. The structure as claimed in claim 8, the first and second opening each having a circular shape.

10. The structure as claimed in claim 9, the first and second opening being exactly superposed.

11. The structure as claimed in claim 1, the first insert or the second insert taking the form of a patch or patches.

12. The structure as claimed in claim 1 the first or second inserts comprising a fibrous material.

13. The structure as claimed in claim 9, the first and second inserts comprising respectively a first and a second watermarks or pseudo-watermarks.

14. The structure as claimed in claim 1, the first security element being observable only from one side of the structure.

15. The structure as claimed in claim 1, comprising a first printing support layer, comprising a thermoplastic material, under the first external layer.

16. The structure as claimed in claim 2, comprising a second printing support layer comprising a thermoplastic material, under the second external layer.

17. The structure as claimed in claim 2, the first and second security elements cooperating in transmitted light.

18. The structure as claimed in claim 17, the security elements being watermarks or pseudo-watermarks.

19. The structure as claimed in claim 17, the first and second security elements respectively comprising a set of elementary patterns or a coded image, and an optical structure giving an image of at least a part of the elementary patterns or of the coded image.

20. The structure as claimed in claim 1, the thermoplastic material of the substrate or of the first or second external layer being transparent or translucent.

21. The structure as claimed in claim 1, the substrate comprising an electronic device.

22. The structure as claimed in claim 1, complying with the dimensional specifications of the standard ISO10373.

23. The structure as claimed in claim 1, the first or the second internal layers being opaque.

24. The structure as claimed in claim 1, the substrate comprising polycarbonate.

25. The structure as claimed in claim 1, comprising at least one layer of adhesive on the first insert.

26. The structure as claimed in claim 1, the substrate accommodating a wired antenna.

27. The structure as claimed in claim 1, the first insert comprising elementary patterns or a coded image, which may be observed through a revelation screen or a lens array carried by the structure.

28. The structure as claimed in claim 27 dependent on claim 2, the revelation screen or the lens array being carried by the second insert.

29. The structure as claimed in claim 1, the substrate being translucent and diffusing light.

30. The structure as claimed in claim 29, the first insert carrying a watermark or pseudo-watermark that is only observable from one face of the structure.

31. The structure as claimed in claim 1, comprising printing on the first external layer or on a layer adjacent to this first external layer.

32. An article, comprising the structure as claimed in claim 1.

33. An article as claimed in claim 32, being a security document, chosen from amongst an access or identification card, a page of a passport, a page of data relating to the carrier of the document.

34. A method for authenticating an article as claimed in claim 32, in which information relating to the authenticity of the article or of the structure is extracted from an observation through the first security element and the non-opaque region.

35. The method as claimed in the claim 34, in which each security element is observed from a corresponding face of the structure and information relating to the authenticity of the article or of the structure is extracted from this observation.
